(19) United States
(12) Patent Application Publication
(10) Pub. No.: US 2003/0160748 A1
(43) Pub. Date: Aug. 28, 2003

(54) Display control circuit, semiconductor device, and portable device

(76) Inventor: Takashi Kimura, Shiojiri-shi (JP)

Correspondence Address: HARNESS, DICKEY & PIERCE, P.L.C., P.O. BOX 828, BLOOMFIELD HILLS, MI, 48303, US

(21) Appl. No.: 10/361,803

(22) Filed: Feb. 10, 2003

(30) Foreign Application Priority Data
Feb. 21, 2002 (JP) 2002-044639

(51) Int. Cl. G09G 3/36

(52) U.S. Cl. 345/87

(57) ABSTRACT

A display control circuit is provided that can display pictures in different color resolutions in a plurality of regions with a small memory capacity. The circuit is equipped with a selector that selects picture data from a memory or picture data from an external equipment, a timing control section that outputs a timing signal representing whether image data corresponds to a first display region or to a second display region, a FIFO buffer that retains image data, a picture pattern storage register that stores predetermined picture patterns, a decoder that decodes image data with a predetermined color resolution according to the timing signal, a lookup table storage section that renders a predetermined conversion on moving picture data, and an LCD module interface section that outputs image data provided from the lookup table storage section to an LCD module.

### TECHNICAL FIELD

The present invention relates to a display control circuit that controls a display device such as an LCD panel or the like, and moreover the present invention relates to a semiconductor device equipped with such a display control circuit and a portable apparatus that is equipped with such a semiconductor device.

### BACKGROUND

In recent years, portable devices such as PDAs (personal data assistances) use a display device such as an LCD panel to display pictures. Moreover, a display screen of an LCD panel may be divided into a plurality of regions and pictures are displayed in the plurality of regions, respectively.

FIG. 11 shows an example of such a conventional display screen of an LCD panel of a portable telephone apparatus. As shown in FIG. 11, the display screen of the LCD panel includes a first display region 51 and a second display region 52. In FIG. 11, the first display region 51 shows a still picture having a color resolution of 24 bpp (bits per pixel), and the second display region 52 shows a moving picture having a color resolution of 24 bpp.

Generally, since moving pictures require a high picture quality, a color resolution of about 24 bpp (with which a display in 16,777,216 colors is possible) is often required. On the other hand, still pictures do not require a picture quality as high as that of a moving picture, and therefore a color resolution of about 8 bpp (with which a display in 256 colors is possible) is often sufficient. However, in the conventional art, as shown in FIG. 11, when a still picture is displayed in the first display region 51 of the LCD panel and a moving picture is displayed in the second display region 52, the still picture and the moving picture need to have the same color resolution.

In other words, to display a moving picture having a color resolution of 24 bpp in the second display region 52, a still picture having a color resolution of 24 bpp needs to be displayed in the first display region 51. As a result, a large capacity memory is required to store the picture data of still pictures.

In connection with the above, Japanese laid-open patent application (Tokkai) HEI 9-281993 (hereinafter referred to as “Reference 1”) describes a data driver that outputs a liquid crystal driving voltage to be applied to each data line of a liquid crystal panel according to display data that is externally inputted. The data driver includes a data processing system that is equipped with a data bus that receives an input of display data from outside, an address bus that receives an input of an address from outside, a display memory that stores display data, and an output bus that outputs data read from the display memory, wherein display data inputted through the data bus is temporarily stored in a region on the display memory which is defined based on an address inputted through the address bus, and then the display data stored in the display memory is successively read out according to an independently predetermined order and outputted through the output bus; a selection means that selects one of the output bus and the data bus of the data processing system; and a voltage output means that outputs a liquid crystal driving voltage according to data that is sent through one of the buses being selected by the selection means.

However, the data driver described in Reference 1 selects picture data (still picture data and the like) stored in the display memory or picture data (moving picture data and the like) stored in the picture data which is selected by the selection means, and outputs a liquid crystal driving voltage according to the picture data being selected, and does not decode picture data with a color resolution of the picture data.

Also, Tokkai 2000-284758 (hereafter referred to as “Reference 2”) describes an information display apparatus that is equipped with a liquid crystal display element having a memory property in which chiral-nematic liquid crystal that shows a cholesteric phase at room temperature is sandwiched between scanning electrode groups and signal electrode groups, wherein a picture is displayed by driving in matrix the liquid crystal element; and it is equipped with a means that selects an update starting line and an update end line of a display screen. The information display apparatus displays a moving picture in a region between the starting line and the end line.

However, the information display apparatus described in Reference 2 is an information display apparatus that driver in matrix a liquid crystal display element having a memory property which sandwiches chiral-nematic liquid crystal to thereby display a picture, and is equipped with a means that selects an update starting line and an update end line of a display screen and displays a moving picture in a region between the starting line and the end line, but does not decode picture data with a color resolution of the picture data.

Also, Tokkai SHO 62-229286 (hereafter referred to as “Reference 3”) describes a picture display control apparatus that converts picture information read from a frame buffer according to a dot clock into a video signal and has a CRT display the same in synchronism with a horizontal synchronizing signal and a vertical synchronizing signal. The picture display control apparatus includes an input-frequency automatic tracking type television receiver including a CRT, a designation means that designates a screen resolution of the television picture receiver, and a CRT controller that is initialized in response to a designation by the designation means and switches a horizontal synchronizing frequency and a vertical synchronizing frequency.

However, the picture display control apparatus described in Reference 3 switches multiple screens of different screen resolutions and displays one of them on the input-frequency automatic tracking type television receiver, but does not display pictures having different color resolutions in a plurality of display regions in a display screen.

Further, Tokkai HEI 5-30440 (hereafter referred to as “Reference 4”) describes a two-screen display television receiver that can simultaneously display a master screen and a slave screen, which is equipped with an A/D converter means that samples a signal of the slave screen with a sampling signal of a different frequency to convert the same to a digital signal, a memory means that stores a digital signal of a different sampling frequency provided from the A/D converter means, a demodulation means that reads information of the slave screen from the memory means in synchronism with the timing of the master screen and demodulates the same, and a control means that generates a control signal for selecting a signal whose sampling frequency differs in response to an external instruction representing a multi-gradation display mode or a high resolution display mode, wherein a slave screen signal from the demodulation means is synthesized onto a master screen signal to display a master-slave two-screens.

However, the two-screen display television receiver described in Reference 4 displays a slave screen according to the multi-gradation display mode or the high resolution display mode in a two-screen display television receiver that is capable of simultaneously displaying a master screen and a slave screen, and does not decode picture data with a color resolution of the picture data.

In view of the above, a first object of the present invention is to provide a display control circuit that decodes first picture data having a first color resolution with the first color resolution, and displays a first picture based on the decoded data in a first region of a display screen, and decodes second picture data having a second color resolution with the second color resolution, and displays a second picture based on the decoded data in a second region of the display screen. A second object of the present invention is to provide a semiconductor device equipped with such a display control circuit. A third object of the present invention is to provide a portable apparatus that is equipped with such a semiconductor device.

### SUMMARY

To solve the problems described above, a display control circuit in accordance with a first aspect of the present invention is characterized in that, when connected to a memory that stores first picture data having a first color resolution and second picture data having a second color resolution, the circuit decodes the first picture data with the first color resolution, and controls a display apparatus to display a first picture in a first region of a display screen thereof based on the decoded data, and decodes the second picture data with the second color resolution, and controls the display apparatus to display a second picture in a second region of the display screen of the display screen based on the decoded data.

Here, the memory may include a first memory that stores the first picture data and a second memory that stores the second picture data.

Further, a display control circuit in accordance with a second aspect of the present invention is characterized in that, when connected to a memory that stores first picture data having a first color resolution and connected to an external equipment that outputs second picture data having a second color resolution, the circuit decodes the first picture data with the first color resolution, and controls a display apparatus to display a first picture in a first region of a display screen thereof based on the decoded data, and decodes the second picture data with the second color resolution, and controls the display apparatus to display a second picture in a second region of the display screen of the display screen based on data decoded.

Here, the external equipment may be a moving picture decoder or a digital camera.

Also, in the display control circuit in accordance with the present invention, the first picture may be a still picture and the second picture may be a moving picture. Also, the display control circuit may be further equipped with a buffer section that receives and retains the first or second picture data, a signal generation section that generates a signal that indicates whether picture data retained by the buffer section is picture data for displaying the first picture or picture data for displaying the second picture, and a decoder section that decodes the picture data retained by the buffer section with the first or second color resolution according to the signal. Also, the display control circuit may further be equipped with an picture data storing section that stores picture data for displaying a predetermined pattern, wherein the decode section decodes the picture data retained by the buffer section or the picture data retained by the picture data storing section with a predetermined color resolution according to the signal. Also, the decode section may include a first decoder that decodes red (R) data, a second decoder that decodes green (G) data and a third decoder that decodes blue (B) data. Also, the display apparatus may be an LCD module.

A semiconductor device in accordance with the present invention is equipped with a display control circuit in accordance with the present invention. It may be further equipped with a memory.

Also, a portable apparatus in accordance with the present invention is equipped with a semiconductor device in accordance with the present invention. The portable apparatus may be a portable telephone apparatus or a PDA (Personal Data Assistants).

In accordance with the present invention, first picture data having a first color resolution can be decoded with the first color resolution, and a first picture can be displayed based on the decoded data in a first region of a display screen, and second picture data having a second color resolution can be decoded with the second color resolution, and a second picture can be displayed based on the decoded data in a second region of the display screen. As a result, the memory capacity required to store picture data can be reduced.

### BRIEF DESCRIPTION OF THE DRAWINGS

FIG. 1 shows an outline of a portable apparatus in accordance with an embodiment of the present invention.

FIG. 2 shows a composition of an LCD module shown in FIG. 1.

FIG. 3 shows a display screen of an LCD panel shown in FIG. 2.

FIG. 4 shows a composition of a display and input control section shown in FIG. 1.

FIG. 5 shows a memory map of an address space of a CPU shown in FIG. 4.

FIG. 6 shows a composition of an LCD controller shown in FIG. 4 as a display control circuit in accordance with an embodiment of the present invention.

FIG. 7 shows decoding of image data by a decoder shown in FIG. 6.

FIG. 8 shows decoding of image data by the decoder shown in FIG. 6.

FIG. 9 shows decoding of image data by the decoder shown in FIG. 6.

FIG. 10 shows a memory map of an address space of the CPU shown in FIG. 4.

FIG. 11 shows a display screen of an LCD panel of a conventional portable telephone apparatus.

### DETAILED DESCRIPTION

An embodiment of the present invention will be described below with reference to the accompanying drawings. It is noted that the same components are assigned the same reference numbers, and their description is not duplicated.

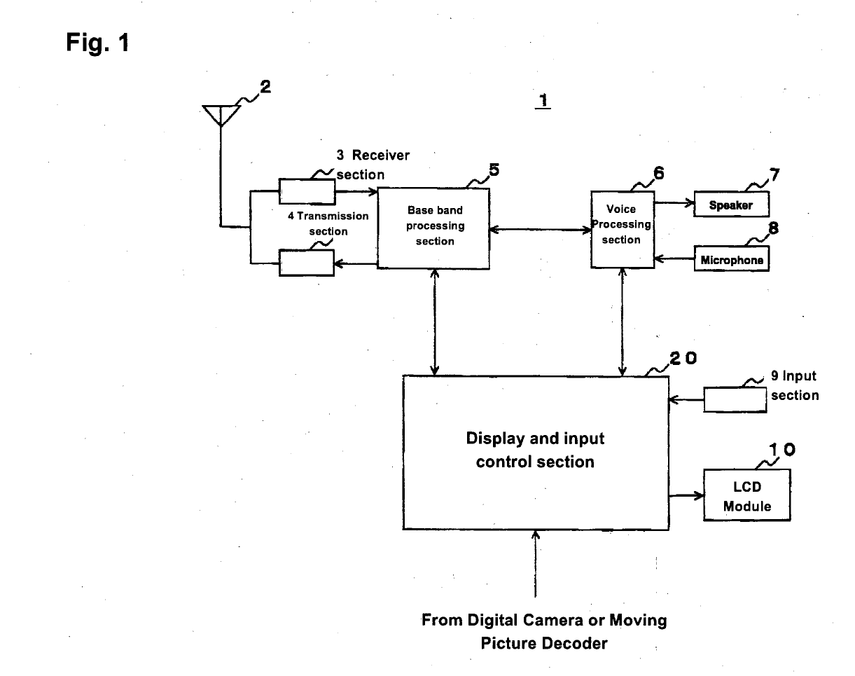

FIG. 1 shows an outline of a portable apparatus in accordance with an embodiment of the present invention. The present embodiment is one in which the present invention is applied to a portable telephone apparatus. It is noted that the present invention can also be applied to other devices such as PDAs (personal data assistants).

As shown in FIG. 1, the portable telephone apparatus 1 is equipped with an antenna 2, a receiver section 3, a transmission section 4, base band processing section 5, a voice processing section 6, a speaker 7, a microphone 8, an input section 9, an LCD module 10 and a display and input control section 20.

The receiver section 3 receives radio waves in a portable telephone frequency band through the antenna 2. The transmission section 4 transmits radio waves in the portable telephone frequency band through the antenna 2. The base band processing section 5 receives signals in the portable telephone frequency band from the receiver section 2 and performs a base band processing on the same, sends voice data to the voice processing section 6, and sends picture data, character data, control data and the same to the display and input control section 20. Also, the base band processing section 5 receives voice data from the voice processing section 6, and character data, control data and the like from the display and input control section 20, converts them into signals in the portable telephone frequency band and sends the same to the transmission section 4.

The voice processing section 6 converts voice data received from the base band processing section 5 into voice signals, and has the speaker 7 output voice sounds. Also, the voice processing section 6 converts voice signals received from the microphone 7 into voice data, and sends the same to the base band processing section 5. The input section 9 may be alphanumeric keys or the like with which the user input data or the like.

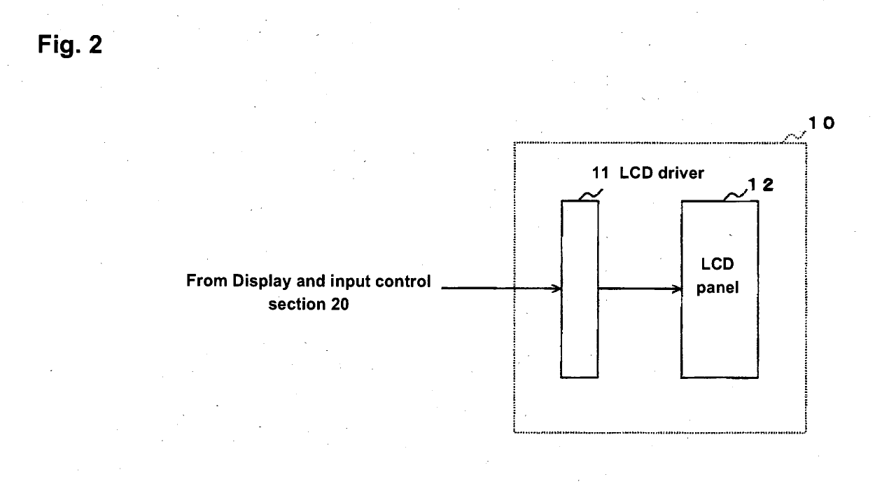

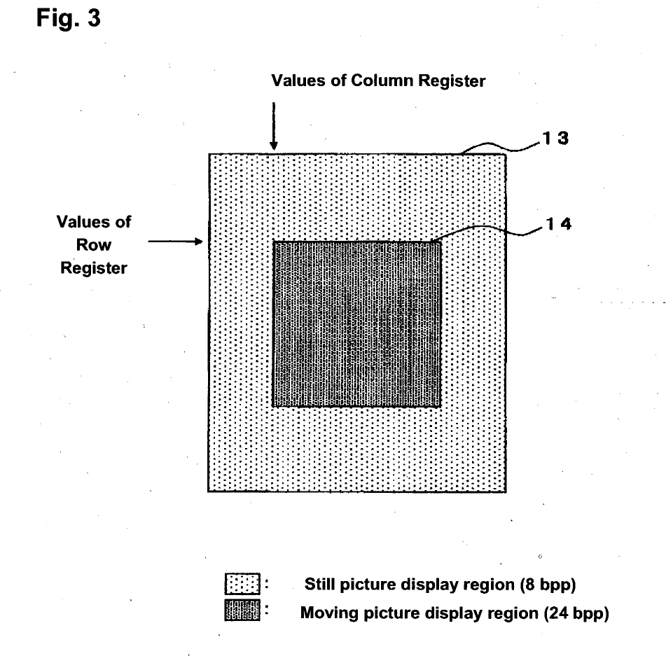

FIG. 2 shows an example of a composition of an LCD module 10 shown in FIG. 1. As shown in FIG. 2, the LCD module 10 includes an LCD panel 12 that displays pictures, characters and the like, and an LCD driver 11 that drives the LCD panel 12. FIG. 3 illustrates a display screen of the LCD panel 12. As shown in FIG. 3, the display screen of the LCD panel 12 is divided into a first display region 13 and a second display region 14, wherein the first display region 13 displays a still picture having a color resolution of 8 bpp (bits per pixel) (with which a display of 256 colors is possible), and the second display region 14 displays a moving picture having a color resolution of 24 bpp (with which a display of 16,777,216 colors is possible).

It is noted that, in the present embodiment, the color resolution for still pictures is 8 bpp and the color resolution for moving pictures is 24 bpp because moving pictures generally require a higher picture quality than still pictures. Also, in general, in picture data having a color resolution of 8 bpp, each of red (R) and green (G) is presented with 3 bits, and blue (B) is presented with 2 bits. Also, in general, in picture data having a color resolution of 24 bpp, each of red (R), green (G) and blue (B) is presented with 8 bits.

Referring back to FIG. 1, the display and input control section 20 controls the base band processing section 5 and voice processing section 6 according to input data received from the input section 9. Also, the display and input control section 20 receives data such as picture data and character data from the base band processing section 5, renders a predetermined processing on the data and sends the same to the LCD module 10. Further, the display and input control section 20 receives picture data from an external digital camera (including a digital still camera and digital video camera) or from a moving picture decoder (using MPEG 4 or another picture compression method), renders a predetermined processing on the picture data and sends the same to LCD module 10.

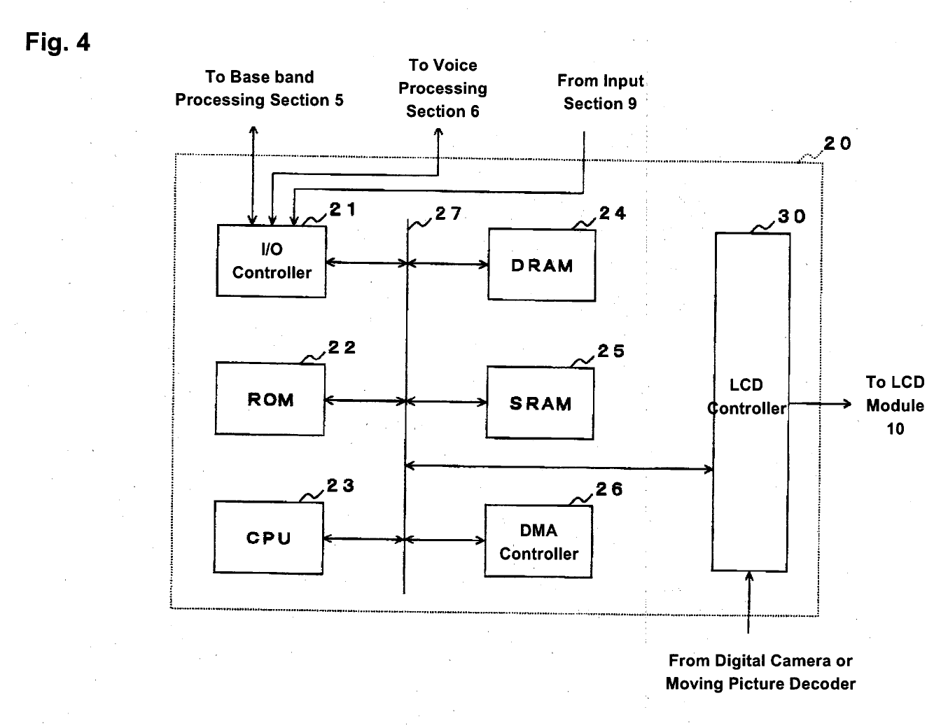

FIG. 4 shows a composition of the display and input control section 20 shown in FIG. 1. As shown in FIG. 4, the display and input control section 20 includes an I/O controller 21, ROM 22, CPU 23, dynamic DRAM 24, static RAM (SRAM) 25, DMA (direct memory access) controller 26, and LCD controller 30. The I/O controller 21, ROM 22, CPU 23, dynamic RAM (DRAM) 24, SRAM 25, DMA controller 26, and LCD controller 30 are mutually connected through a bus 27.

The I/O controller 21 receives data from the base band processing section 5, the voice processing section 6 and the input section 9 and sends the same to the bus 27, and also receives data from the bus 27 and sends the same to the base band processing section 5 and the voice processing section 6.

The ROM 22 stores a program to be executed by the CPU 23. The CPU 23 renders a predetermined processing on data received from the base band processing section 5, the voice processing section 6 and input section 9 by executing the program stored in the ROM 22. Also, the CPU 23 stores picture data in the DRAM 24 and the SRAM 25, and updates picture data stored in the DRAM 24 and the SRAM 25.

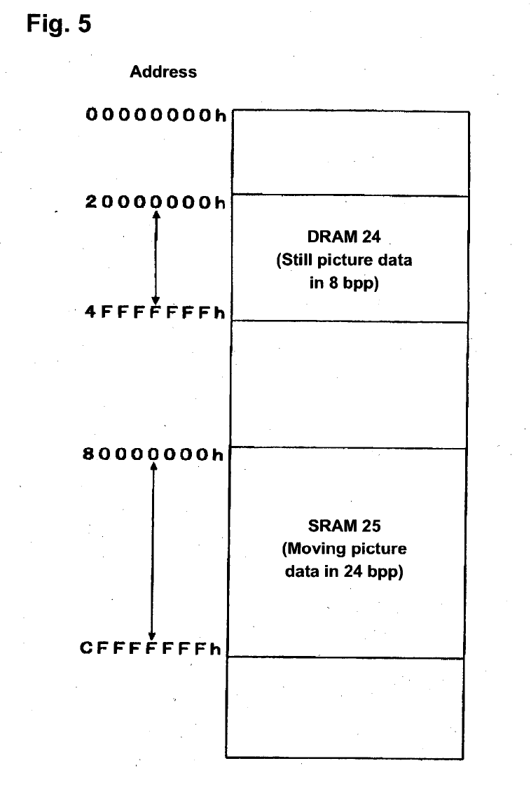

The DRAM 24 and the SRAM 25 are mapped in the address space of the CPU 23, the DRAM 24 stores still picture data having a color resolution of 8 bpp, and the SRAM 25 stores moving picture data having a color resolution of 24 bpp. FIG. 5 shows a memory map of the CPU 23. As shown in FIG. 5, the DRAM 24 is mapped at addresses 20000000h˜4FFFFFFFh of the address space of the CPU 23, and the SRAM 25 is mapped at addresses 80000000h˜CFFFFFFFh of the address space of the CPU 23.

Referring again to FIG. 4, the DMA controller 26 transfers picture data stored in the DRAM 24 or the SRAM 25 to the LCD controller 30 without involving the CPU 23.

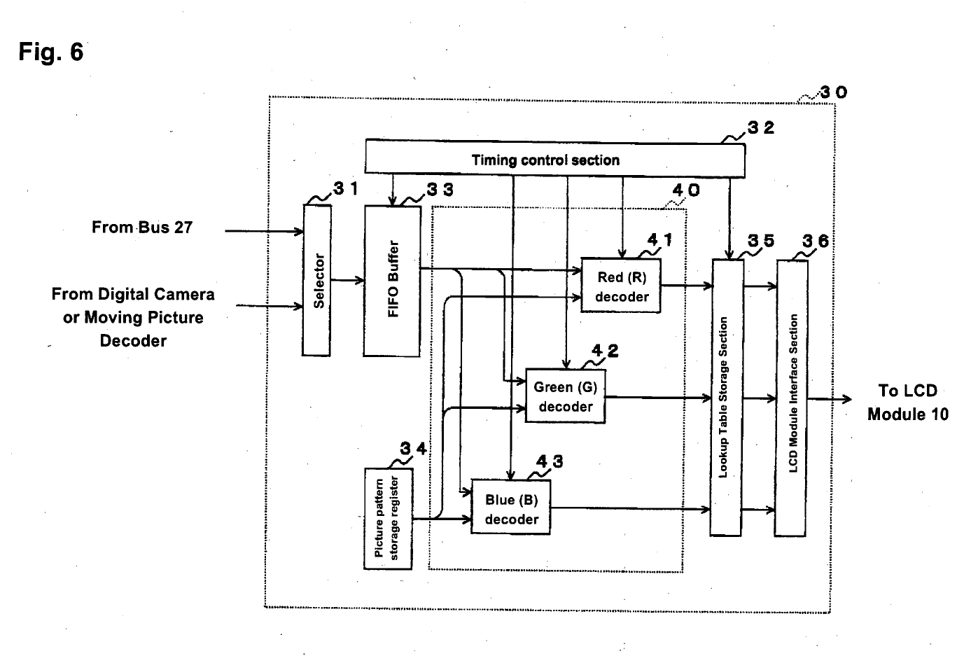

FIG. 6 shows an internal composition of the LCD controller in FIG. 4 as a display control circuit in accordance with an embodiment of the present invention. As shown in FIG. 6, the LCD controller 30 includes a selector 31, timing control section 32, FIFO buffer 33, picture pattern storage register 34, lookup table storage section 35, LCD module interface section 36, and decoder 40. Also, the decoder 40 includes a red (R) decoder 41, green (G) decoder 42 and blue (B) decoder 43.

The selector 31 selects picture data from the bus 27 or picture data from a digital camera or a moving picture decoder, and sends the same to the FIFO 33. The timing control section 32 has a row register and a column register that respectively retain row numbers and column numbers of pixels on the display screen of the LCD panel 12 which correspond to the picture data, and handles the registers correspondence between the picture data and the pixels on the display screen of the LCD panel 12. Also, the timing control section 32 sends a timing signal representing whether the picture data correspond to the pixels within the first display region 13 or to the pixels within the second display region 14 to the FIFO buffer 33, the red (R) decoder 41, the green (G) decoder 42, the blue (B) decoder 43 and the lookup table storage section 35.

The FIFO buffer 33 is a buffer in a 32-bit width, and retains picture data selected by the selector 31 in response to a timing signal outputted from the timing control section 32. More specifically, upon receiving from the timing control section 32 a timing signal representing that the picture data selected by the selector 31 corresponds to the pixels within the first display region 13, in other words, the picture data selected by the selector 31 is still picture data, the FIFO buffer 33 receives from the selector 31 still picture data having a color resolution of 8 bpp, handles data for four pixels of the still picture (32 bits=4 bytes) as one unit, and successively outputs the same to the red (R) decoder 41, the green (G) decoder 42, and the blue (B) decoder 43.

Upon receiving from the timing control section 32 a timing signal representing that the picture data selected by the selector 31 corresponds to the pixels within the second display region 14, in other words, the picture data selected by the selector 31 is moving picture data, the FIFO buffer 33 receives from the selector 31 moving picture data having a color resolution of 24 bpp, handles data for one pixel of the moving picture (24 bits=3 bytes) as one unit, and successively outputs the same to the red (R) decoder 41, the green (G) decoder 42, and the blue (B) decoder 43. In this case, a part (1 byte in each line) of the FIFO buffer 33 is not used.

The picture pattern storage register 34 stores picture data for displaying simple picture patterns, such as, for example, patterns in blue color only, patterns in red color only, stripes and the like. These picture data are used to display an image pattern in place of a still picture in the first display region.

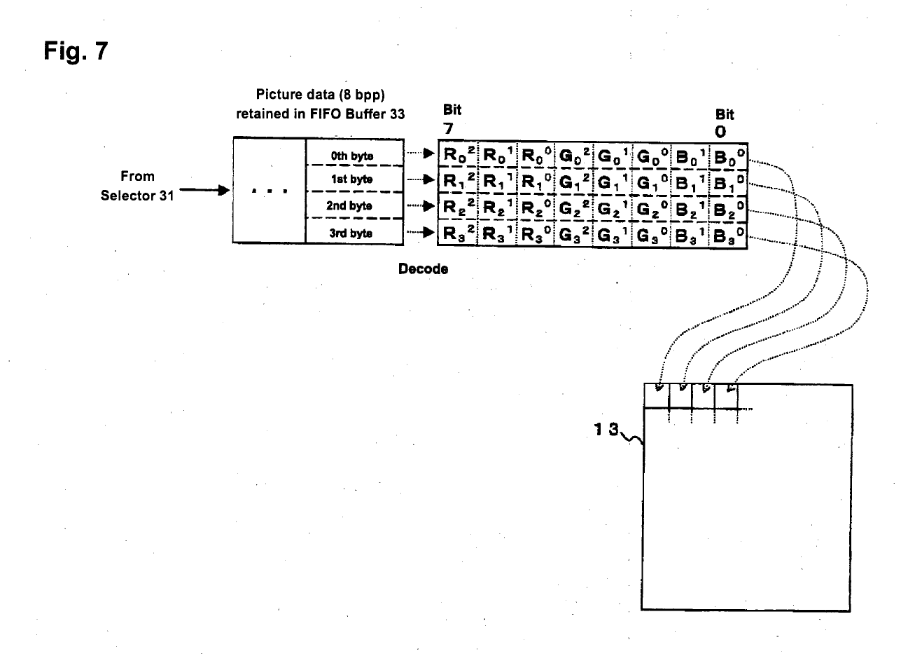

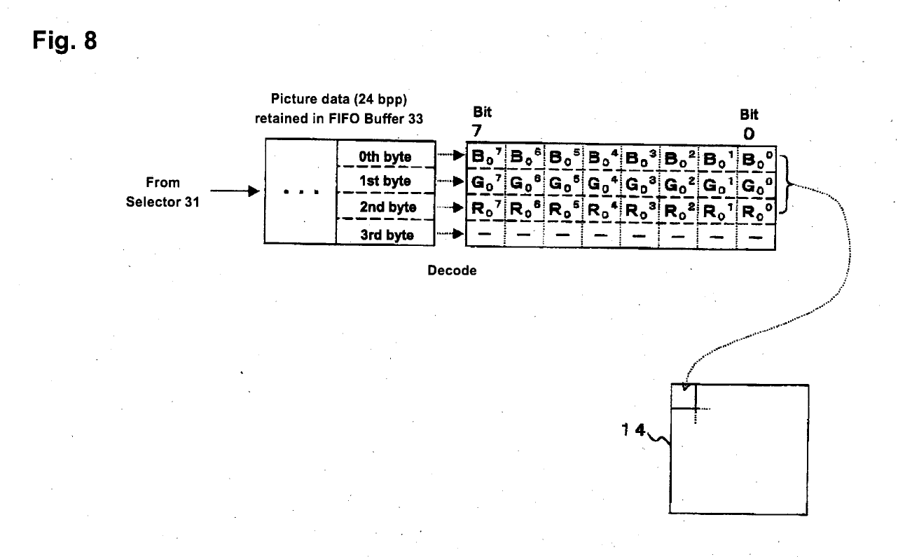

The red (R) decoder 41, the green (G) decoder 42 and the blue (B) decoder 43 decode, according to the timing signal outputted by the timing control section 32, still picture data or moving picture data retained in the FIFO buffer 33 or picture data stored in the picture pattern storage register 34. FIGS. 7 and 8 show operations to decode picture data by the red (R) decoder 41, the green (G) decoder 42 and the blue (B) decoder 43. FIG. 7 shows a decoding operation rendered on still picture data having a color resolution of 8 bpp retained in the FIFO buffer 33, and FIG. 8 shows a decoding operation rendered on moving picture data having a color resolution of 24 bpp retained in the FIFO buffer 33.

Upon receiving from the timing control section 32 a timing signal representing that the picture data retained in the FIFO buffer 33 corresponds to the pixels within the first display region 13, in other words, the picture data retained in the FIFO buffer 33 is still picture data, the red (R) decoder 41 receives the 0^{th} byte from the FIFO buffer 33, and decodes its upper 3 bits as red (R) data of the 0^{th} pixel, as shown in FIG. 7. Similarly, the green (G) decoder 42 decodes the middle 3 bits of the 0^{th} byte as green (G) data of the 0^{th} pixel, and the blue (B) decoder 43 decodes the lower 2 bits of the 0^{th} byte as blue (B) data of the 0^{th} pixel. The picture data of the 0^{th} pixel thus decoded (including red (R) data, green (G) data and blue (B) data) is sent to the LCD module 10, and the 0^{th} pixel in the first display region 13 is displayed based on the picture data, as shown in FIG. 7.

Further, the red (R) decoder 41 receives the 1^{st} byte from the FIFO buffer 33, and decodes its upper 3 bits as red (R) data of the 1^{st} pixel: the green (G) decoder 42 decodes the middle 3 bits of the 1^{st} byte as green (G) data of the 1^{st} pixel, and the blue (B) decoder 43 decodes the lower 2 bits of the 1^{st} byte as blue (B) data of the 1^{st} pixel. The picture data of the 1^{st} pixel thus decoded (including red (R) data, green (G) data and blue (B) data) is sent to the LCD module 10, and the 1^{st} pixel in the first display region 13 is displayed based on the picture data, as shown in FIG. 7.

Also, the red (R) decoder 41 receives the 2^{nd} byte from the FIFO buffer 33, and decodes its upper 3 bits as red (R) data of the 2^{nd} pixel: the green (G) decoder 42 decodes the middle 3 bits of the 2^{nd} byte as green (G) data of the 2^{nd} pixel, and the blue (B) decoder 43 decodes the lower 2 bits of the 2^{nd} byte as blue (B) data of the 2^{nd} pixel. The picture data of the 2^{nd} pixel thus decoded (including red (R) data, green (G) data and blue (B) data) is sent to the LCD module 10, and the 2^{nd} pixel in the first display region 13 is displayed based on the picture data, as shown in FIG. 7.

Also, the red (R) decoder 41 receives the 3^{rd} byte from the FIFO buffer 33, and decodes its upper 3 bits as red (R) data of the 3^{rd} pixel: the green (G) decoder 42 decodes the middle 3 bits of the 3^{rd} byte as green (G) data of the 3^{rd} pixel, and the blue (B) decoder 43 decodes the lower 2 bits of the 3^{rd} byte as blue (B) data of the 3^{rd} pixel. The picture data of the 3^{rd} pixel thus decoded (including red (R) data, green (G) data and blue (B) data) is sent to the LCD module 10, and the 3^{rd} pixel in the first display region 13 is displayed based on the picture data, as shown in FIG. 7.

In the meantime, upon receiving from the timing control section 32 a timing signal representing that the picture data retained in the FIFO buffer 33 corresponds to the pixels within the second display region 14, in other words, the decoder 40 outputs moving picture data, the red (R) decoder 41 receives the 2^{nd} byte from the FIFO buffer 33, and decodes it as red (R) data, as shown in FIG. 8. Similarly, the green (G) decoder 42 receives the 1^{st} byte from the FIFO buffer 33, and decodes it as green (G) data, and the blue (B) receives the 0^{th} byte from the FIFO buffer 33, and decodes it as blue (B) data. The picture data thus decoded (including red (R) data, green (G) data and blue (B) data) is sent to the LCD module 10, and the pixel in the second display region 14 is displayed based on the picture data, as shown in FIG. 8.

Referring back to FIG. 6, the lookup table storage section 35 stores a lookup table for rendering a predetermined conversion on the moving picture data outputted from the decoder 40 (for example, conversion to match the moving picture data with the picture display characteristic of the LCD panel 12 and the like). Upon receiving from the timing control section 32 a timing signal representing that the picture data to be outputted from the decoder 40 corresponds to the pixels within the second display region 14, in other words, the decoder 40 outputs moving picture data, the lookup table storage section 35 renders a predetermined conversion on the moving picture data outputted from the decoder 40, and sends the same to the LCD module 10 through the LCD module interface section 36.

Upon receiving from the timing control section 32 a timing signal representing that the picture data to be outputted from the decoder 40 corresponds to the pixels within the first display region 13, in other words, the decoder 40 outputs still picture data, the lookup table storage section 35 does not convert the still picture data outputted from the decoder 40 and sends the same without any change to the LCD module 10.

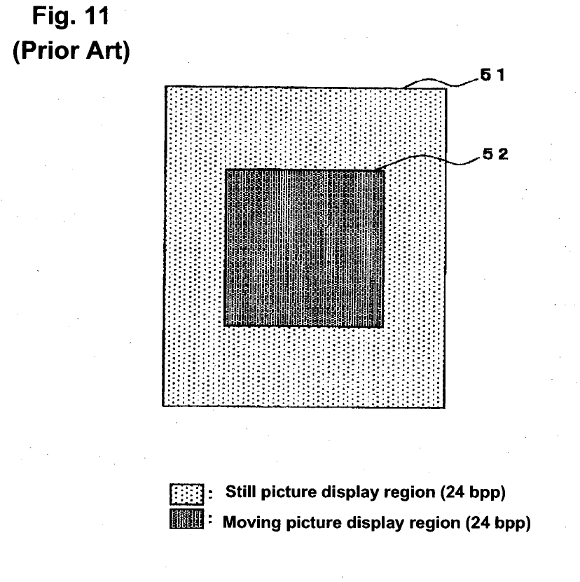

In this manner, the portable telephone apparatus 1 displays a still picture having a color resolution of 8 bpp in the first display region 13, and a moving picture having a color resolution of 24 bpp in the second display region 14. Consequently, the size of still picture data can be reduced and the memory capacity of the DRAM 24 for storing the still picture data can be reduced compared to the case of the conventional portable telephone apparatus shown in FIG. 11 in which a still picture having a color resolution of 24 bpp is displayed in the first display region 51 and a moving picture having a color resolution of 24 bpp is displayed in the second display region 52.

Also, since the size of still picture data can be reduced, the bus cycle number necessary for transferring the still picture data can be reduced, and power consumption can be reduced.

Furthermore, since the bus cycle number necessary for transferring still picture data can be reduced, the usage time of the bus for transferring still picture data can be shortened, and the time during which the CPU 23 can use the bus can be extended, which improves the performance of the CPU 23.

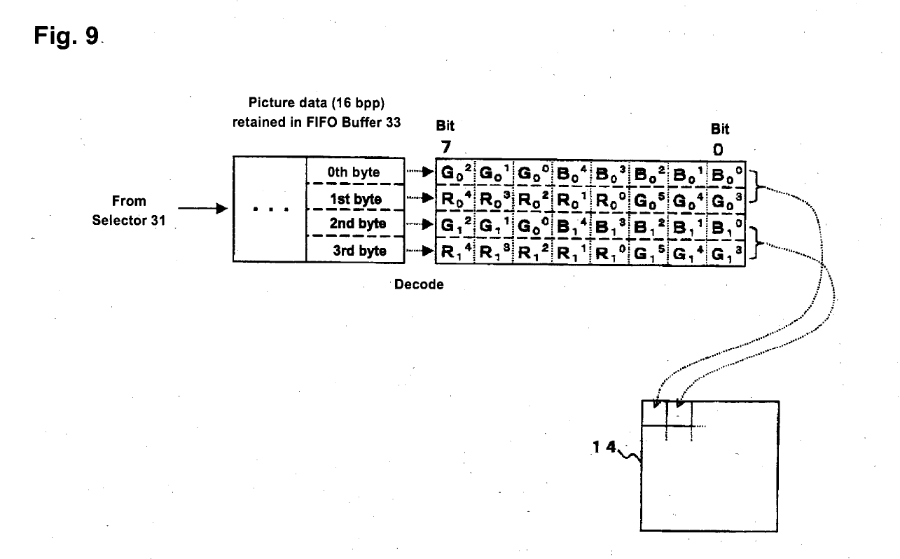

In the present embodiment, the color resolution of moving picture data that is stored in the SRAM 25 is 24 bpp. However, it may be 16 bpp (for example, 5 bits for red (R), 6 bits for green (B) and 5 bits for blue (B)). In this case, as shown in FIG. 9, the red (R) decoder 41 receives the 1^{st} byte from the FIFO buffer 33, and decodes its upper 5 bits as red (R) data of the 0^{th} pixel: the green (G) decoder 42 decodes the lower 3 bits of the 1^{st} byte and the upper 3 bits of the 0^{th} byte as green (G) data of the 0^{th} pixel; and the blue (B) decoder 43 decodes the lower 5 bits of the 0^{th} byte as blue (B) data of the 0^{th} pixel. The picture data of the 0^{th} pixel thus decoded (including red (R) data, green (G) data and blue (B) data) is sent to the LCD module 10, and the 0^{th} pixel in the second display region 14 is displayed based on the picture data, as shown in FIG. 9.

Also, the red (R) decoder 41 receives the 3^{rd} byte from the FIFO buffer 33, and decodes its upper 5 bits as red (R) data of the 1^{st} pixel: the green (G) decoder 42 decodes the lower 3 bits of the 3^{rd} byte and the upper 3 bits of the 2^{nd} byte as green (G) data of the 1^{st} pixel; and the blue (B) decoder 43 decodes the lower 5 bits of the 2^{nd} byte as blue (B) data of the 1^{st} pixel. The picture data of the 1^{st} pixel thus decoded (including red (R) data, green (G) data and blue (B) data) is sent to the LCD module 10, and the 1^{st} pixel in the second display region 14 is displayed based on the picture data, as shown in FIG. 9.

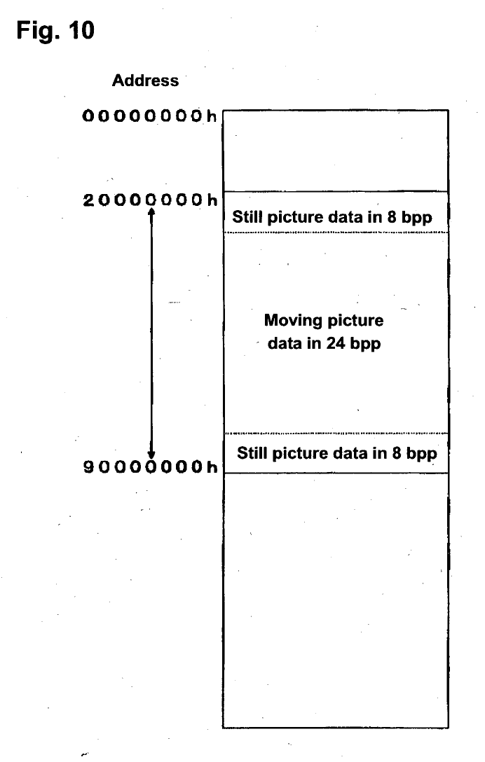

It is noted that the LCD controller 30 may include the DRAM 24 or the SRAM 25. Also, in the present embodiment, the DRAM 24 stores still picture data, and the SRAM 25 stores moving picture data. However, as shown in FIG. 10, a single memory (for example, SRAM) may be mapped in the address space of the CPU 23, and still picture data and moving picture data can be stored in the memory. In this manner, by storing still picture data and moving picture data in one memory, a redundant memory region for storing still picture data corresponding to the second display region 14 where a moving picture is displayed but a still picture is not displayed can be eliminated.

As described above, in accordance with the present invention, first picture data having a first color resolution can be decoded with the first color resolution, and a first picture can be displayed based on the decoded data in a first region of a display screen; and second picture data having a second color resolution can be decoded with the second color resolution, and a second picture can be displayed based on the decoded data in a second region of the display screen. As a consequence, the memory capacity required for storing image data can be reduced.

The entire disclosure of Japanese Patent Application No. 2002-044639 filed Feb. 21, 2002 is incorporated by reference herein.

What is claimed is:

1. A display control circuit method comprising:
connecting the circuit to a memory that stores first picture data having a first color resolution and second picture data having a second color resolution;
decoding the first picture data with the first color resolution, and controlling a display apparatus to display a first picture in a first region of a display screen based on the decoded data; and
decoding the second picture data with the second color resolution, and controlling the display apparatus to display a second picture in a second region of the display screen based on the decoded data.

2. The display control circuit method according to claim 1, wherein the memory includes a first memory that stores the first picture data and a second memory that stores the second picture data.

3. A display control circuit method comprising:
connecting the circuit to a memory that stores first picture data having a first color resolution and to an external device that outputs second picture data having a second color resolution;
decoding the first picture data with the first color resolution, and controlling a display apparatus to display a first picture in a first region of a display screen based on the decoded data; and
decoding the second picture data with the second color resolution, and controlling the display apparatus to display a second picture in a second region of the display screen based on the decoded data.

4. The display control circuit method according to claim 3, wherein the external device is a moving picture decoder or a digital camera.

5. The display control circuit method according to claim 3, wherein the first picture is a still picture and the second picture is a moving picture.

6. The display control circuit method according to claim 3, further comprising:
receiving and retaining at least one of the first and second picture data in a buffer section;
generating a signal in a signal generation section that indicates whether picture data retained by the buffer section is picture data for displaying the first picture or picture data for displaying the second picture; and
decoding the picture data retained by the buffer section in a decoder section with the first or second color resolution according to the signal.

7. The display control circuit method according to claim 6, further comprising storing picture data in a picture data storing section for displaying a predetermined pattern, wherein the decoder section decodes the picture data retained by the buffer section or the picture data retained by the picture data storing section with a predetermined color resolution according to the signal.

8. The display control circuit method according to claim 6, wherein the decode section includes a first decoder that decodes red (R) data, a second decoder that decodes green (G) data and a third decoder that decodes blue (B) data.

9. The display control circuit method according to claim 3, wherein the display apparatus further comprises an LCD module.

10. The display control circuit method according to claim 1, wherein the first picture is a still picture and the second picture is a moving picture.

11. The display control circuit method according to claim 1, further comprising:
receiving and retaining at least one of the first and second picture data in a buffer section;
generating a signal in a signal generation section that indicates whether picture data retained by the buffer section is picture data for displaying the first picture or picture data for displaying the second picture; and
decoding the picture data retained by the buffer section in a decoder section with the first or second color resolution according to the signal.

12. The display control circuit method according to claim 11, further comprising storing picture data in a picture data storing section for displaying a predetermined pattern, wherein the decoder section decodes the picture data retained by the buffer section or the picture data retained by the picture data storing section with a predetermined color resolution according to the signal.

13. The display control circuit method according to claim 12, wherein the decode section includes a first decoder that decodes red (R) data, a second decoder that decodes green (G) data and a third decoder that decodes blue (B) data.

14. The display control circuit method according to claim 1, wherein the display apparatus further comprises an LCD module.
